(19) United States
(12) Patent Application Publication
(10) Pub. No.: US 2010/0159207 A1
(43) Pub. Date: Jun. 24, 2010

(54) Cellulose Cloth

(75) Inventor: Andreas Schmidt, Duderstadt (DE)

Correspondence Address: GUDRUN E. HUCKETT DRAUDT, SCHUBERTSTR. 15A, WUPPERTAL, 42289, DE

(73) Assignee: MCAIRLAID'S VLIESSTOFFE GMBH & CO. KG, Berlingerode (DE)

(21) Appl. No.: 12/645,503

(22) Filed: Dec. 23, 2009

(30) Foreign Application Priority Data
Dec. 23, 2008 (DE) 20 2008 016 926.7

(51) Int. Cl. B32B 3/30; B32B 3/10; B32B 7/04; B32B 7/12

(52) U.S. Cl. 428/172; 428/196

(57) ABSTRACT

A cellulose cloth has a fiber layer of cellulose fibers that absorb liquids as well as a second layer bonded thereto, wherein the second layer has a different color or a different color pattern than the fiber layer, and wherein the fibers of the fiber layer are bonded to one another by partial press-bonding with compression of the cellulose fibers in the press-bonded areas.

### BACKGROUND OF THE INVENTION

The invention concerns a cellulose cloth that can be used, for example, as a tablecloth or a napkin.

Tablecloths and napkins are available commercially in different materials and qualities. For big events, so-called disposable tablecloths and napkins of paper are often used. These cloths are thin and their absorption is only minimal, they serve purely for decorative purposes, i.e., to cover the table surface. Also, the protective and cleaning function when the cellulose cloth is in the form of a napkin is not satisfactory.

### SUMMARY OF THE INVENTION

The invention has the object to provide a cellulose cloth that is especially suitable for use as tablecloth or napkins, that is of a soft product quality and that is characterized by excellent absorption of hydrophilic and hydrophobic materials and liquids.

As a solution to this object a cellulose cloth is proposed that comprises a fiber layer of cellulose fibers that absorb liquids as well as at least one second layer bonded thereto wherein the second layer has a different color or a different color pattern than the fiber layer and wherein the cellulose fibers of the fiber layer are partially press-bonded with compression of the cellulose fiber in the compressed areas.

Such a cellulose cloth is characterized by a soft and supple feel for which reason it is especially suitable for use as a table napkin or tablecloth. The fiber layer of cellulose fibers absorbs especially well hydrophilic and hydrophobic materials and retains them in the cellulose cloth. Advantageous for the appearance as a napkin or tablecloth is moreover the two-color or multi-color appearance in that the second layer is colored in a color that differs from the color of the cellulose fibers of the fiber layer or is printed with one or several color patterns.

One embodiment proposes that the cellulose fibers in the press-bonded areas are press-bonded with heat application. In a possible embodiment the fiber layer and the second layer are also bonded to one another by partial press-bonding by means of heat application. The manufacture of such bonded cellulose fibers and fiber layers or fiber webs is disclosed in German patent application DE 19803837A1 and European patent EP1032342B1.

A further embodiment proposes that the press-bonded areas are embossed areas with formation of depressions within the fiber layer. The embossed areas or depressions can be round or polygonal in cross-section. In particular, the embossed areas or depressions in their totality can provide a decorative pattern which is in particular advantageous when manufacturing napkins form the cellulose cloth of the present invention.

### BRIEF DESCRIPTION OF THE DRAWINGS

The invention is illustrated in the attached Figures in more detail.

FIG. 1 is a perspective illustration of a cellulose cloth with two layers.

FIG. 2 is a perspective illustration of a cellulose cloth with three layers.

### DESCRIPTION OF PREFERRED EMBODIMENTS

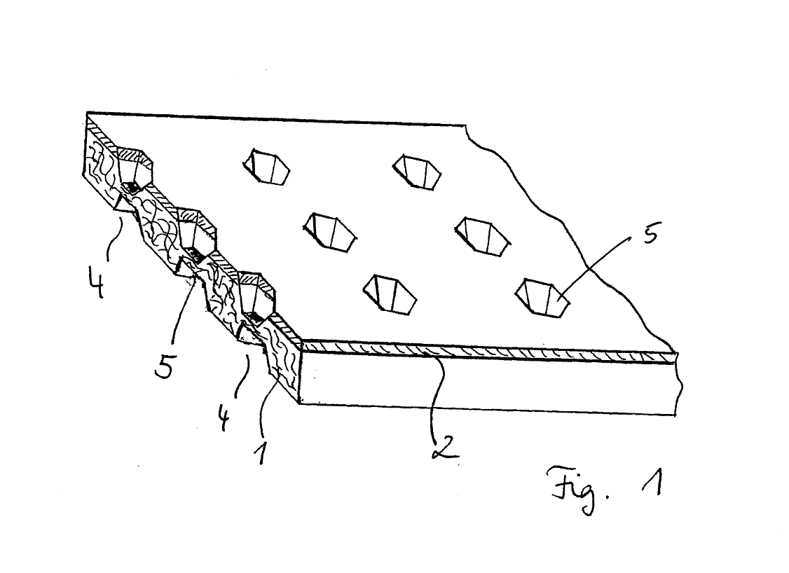

In FIG. 1 a cellulose cloth according to the invention of two layers 1, 2 is shown in perspective illustration on an enlarged scale with regard to thickness. The lower significantly thicker layer is a fiber layer 1 of cellulose fibers, optionally of a super-absorbent polymer (SAP). The layer is preferably produced of cellulose material by an airlaid method. Such cellulose material is inexpensively available as a mass-produced material. When manufacturing by a continuous airlaid method, the fiber material web is produced from bulk cellulose fibers of cellulose (fluff pulp) laid in an air stream; optionally, absorber materials are interspersed. For the manufacture of a standardized product it is possible to use commercially available renewable wood products.

The method of airlaying cellulose as a starting material for the fiber layer 1 enables dry processing of the cellulose fibers and thus, in the subsequent bonding step with the second layer, an excellent fusion of the cellulose fibers in individual, i.e., discrete, embossed areas 4. Outside of such embossed areas the fibers are loosely resting on one another; this improves the absorption and the flexibility of the fiber layer 1.

The second layer 2 is substantially thinner than the fiber layer 1. The second layer 2, for example, can be formed of a web of textile, nonwoven-like or film-like material. It may have the same basic color as the fiber layer 1 or can differ therefrom. In one possible embodiment the fiber layer 1 and the second layer 2 are of the same basic color wherein, subsequent to flat stacking of the two layers 1, 2 on one another, one of the layers is color-printed.

In a further embodiment the second layer 2 has a basic color that is different from the color of the preferably unbleached cellulose fibers of the fiber layer 1 wherein also this differently colored layer 2 can be printed in a subsequent process step, for example, with a pattern.

The bonding of the two layers 1, 2 after flat stacking of the layers is realized by an embossing method, for example. In this connection, a partial press-bonding with compression of individual areas of the cellulose fibers of the fiber layer 1 and the corresponding areas of the layer 2 takes place.

The press-bonding action is not uniform across large surface areas but press-bonding takes place mainly in the embossed areas 4 wherein at least in the fiber layer 1 depressions 5 are formed. The depressions 5 in the embossed areas 4 can be round or polygonal in cross-section. In the illustrated embodiment, they have the configuration of truncated pyramids or truncated cones, preferably of hexagonal truncated pyramids.

As a result of the thin-walled configuration of the second layer 2 the embossment pattern that results upon press-bonding is also recognizable on the exterior face of the second layer 2 so that its design or appearance is positively affected. In particular, the embossed areas 4 can be arranged like a pattern and in particular like a decorative pattern.

The embossment is realized between two oppositely rotating rollers, wherein one of the two rollers is provided with structures for forming the depressions 5. These structures are pyramids or truncated cones projecting from the respective exterior roller surface. In this way, in the discrete embossed areas 4 an increased pressure and a high compression of the cellulose fibers are achieved. Outside of the embossed areas 4 the fibers rest loosely on one another so that the absorption and the flexibility of the layer 1 are left untouched. When producing the cellulose cloth, neither adhesives nor other binders, for example, latex, are required. Instead, the bonding action is realized by the applied pressure and the temperature increase produced thereby. The weight per unit area of the fiber layer 1 can be between 15 g/m² and 600 g/m². Preferably, the weight per unit area is between 20 g/m² and 200 g/m².

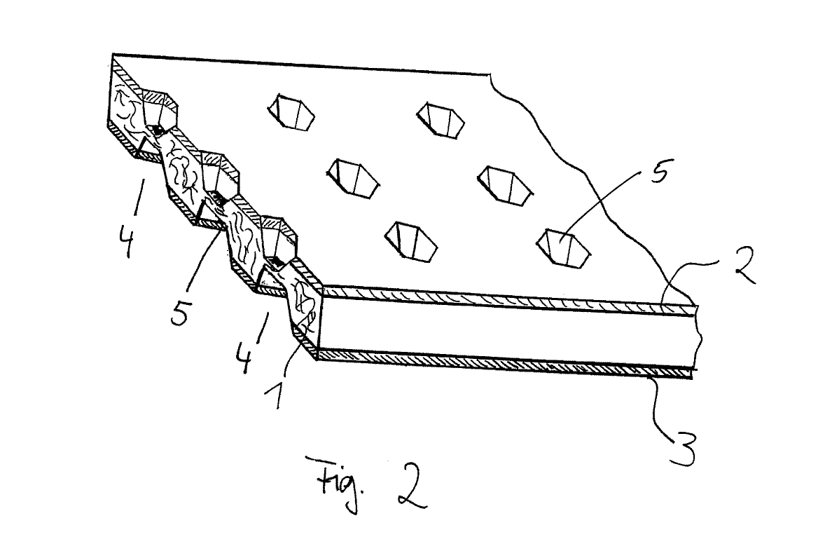

FIG. 2 shows a further embodiment of the present invention, i.e., a cellulose cloth with three layers. In this embodiment, the fiber material web 1 has bonded thereto on both faces further webs 2, 3 of textile, nonwoven-like or film-like material. The webs 2 and 3 can be of the same or also of different materials. The webs 2 and 3 each can be bonded independent from one another with the fiber layer 1 and/or fused and/or, as described above, bonded therewith by embossment. In the illustrated embodiment the webs 2 and 3 are bonded by partial press-bonding with the fiber layer 1 so that on both faces an embossed pattern is formed.

A smooth surface structure is obtained, for example, when the webs 2 and/or 3 are/is placed on the fiber layer 1 and the fiber layer 1 and the web 2 and/or web 3 are areally adhesively bonded, as is known in the art, or in another way. The surface structure of the finished cellulose cloth can be determined by the type of bonding of the fiber layer 1 with one or two webs 2, 3. Also, by means of the color design and pattern selection of the web(s) 2, 3 the visual appearance of the cellulose cloth according to the invention can be varied.

A further subject matter of the present invention concerns a tablecloth that is produced from a cellulose cloth as described supra.

Yet another additional subject matter of the present invention concerns a napkin that is produced of a cellulose cloth as described supra.

Napkins and tablecloths or table runners of the cellulose cloth according to the invention have the advantage that the variation possibilities are much more comprehensive in comparison to conventional napkins of airlaid materials that are only available as monochrome materials. Moreover, the cellulose cloth exhibits a significantly improved absorption of hydrophilic and hydrophobic materials; also, they are very soft and therefore have a very pleasant feel.

The specification incorporates by reference the entire disclosure of German priority document 20 2008 016 926.7 having a filing date of Dec. 23, 2008.

While specific embodiments of the invention have been shown and described in detail to illustrate the inventive principles, it will be understood that the invention may be embodied otherwise without departing from such principles.

What is claimed is:

1. A cellulose cloth comprising:
a fiber layer of cellulose fibers that absorb liquids;
a second layer bonded to the fiber layer;
wherein the second layer has a different color or a different color pattern than the fiber layer; and
wherein the cellulose fibers of the fiber layer are bonded to one another by partial press-bonding with compression of the cellulose fibers in the press-bonded areas.

2. The cellulose cloth according to claim 1, wherein the color or the color pattern is applied by printing.

3. The cellulose cloth according to claim 1, wherein the cellulose fibers in the press-bonded areas are press-bonded with heat application.

4. The cellulose cloth according to claim 1, comprising a third layer that is arranged on a face of the fiber layer which face is facing away from the second layer.

5. The cellulose cloth according to claim 4, wherein the second and third layers have a color or color pattern that is different from the color or color pattern of the fiber layer.

6. The cellulose cloth according to claim 5, wherein the second and third layers differ from one another with regard to the color or the color pattern.

7. The cellulose cloth according to claim 4, wherein the second and third layers are selected from textile material, nonwoven material or film material.

8. The cellulose cloth according to claim 4, wherein the press-bonded areas are embossed areas forming depressions in the fiber layer.

9. The cellulose cloth according to claim 8, wherein the fiber layer and the second and third layers are bonded to one another in the embossed areas.

10. The cellulose cloth according to claim 4, wherein the fiber layer and the second and third layers are areally connected to one another adhesively.

11. The cellulose cloth according to claim 1, wherein the press-bonded areas are embossed areas forming depressions in the fiber layer.

12. The cellulose cloth according to claim 11, wherein the depressions are round or polygonal in cross-section.

13. The cellulose cloth according to claim 11, wherein the depressions together from a decorative pattern.

14. The cellulose cloth according to claim 11, wherein the fiber layer and the second layer are bonded to one another in the embossed areas.

15. The cellulose cloth according to claim 1, wherein the fiber layer and the second layer are areally connected to one another adhesively.

16. The cellulose cloth according to claim 1, wherein the fiber layer has a material density of between 15 g/m² and 600 g/m².

17. The cellulose cloth according to claim 16, wherein the fiber layer has a material density of between 20 g/m² and 200 g/m².

18. A tablecloth comprised of a cellulose cloth according to claim 1.

19. A napkin comprised of a cellulose cloth according to claim 1.
